(19) United States
(12) Patent Application Publication
(10) Pub. No.: US 2013/0167549 A1
(43) Pub. Date: Jul. 4, 2013

(54) COMPRESSOR GUIDE VANE AND PILOT CONTROL FOR GAS TURBINE ENGINE

(71) Applicants: Chad M. Holcomb, San Diego, CA (US); Jason W. Ritchie, San Diego, CA (US)

(72) Inventors: Chad M. Holcomb, San Diego, CA (US); Jason W. Ritchie, San Diego, CA (US)

(21) Appl. No.: 13/339,490

(22) Filed: Dec. 29, 2011

(51) Int. Cl. F02C 9/54

(52) U.S. Cl. 60/773; 60/39.281

(57) ABSTRACT

A method of controlling a turbine engine. The method may include adjusting a position of a plurality of guide vanes of a compressor. The adjusting the position of the plurality of guide vanes may be a function of a compressor temperature signal. The method may further include adjusting a quantity of fuel delivered to a combustor via a pilot assembly. The adjusting of the quantity of fuel may be a function of a temperature difference resulting from the adjusting a position of the plurality of guide vanes.

### TECHNICAL FIELD

The present disclosure relates generally to a gas turbine engine, and more particularly, methods and apparatuses for controlling compressor guide vanes and a pilot assembly of a gas turbine engine.

### BACKGROUND

Gas turbine engines (GTEs) produce power by extracting energy from a flow of hot gas produced by combustion of fuel in a stream of compressed air. In general, GTEs have an upstream air compressor coupled to a downstream turbine with a combustion chamber (combustor) in between. Energy is produced when a mixture of compressed air and fuel is burned in the combustor, and the resulting hot gases are used to spin blades of a turbine. In typical GTEs, multiple fuel injectors direct the fuel to the combustor for combustion. Combustion of typical fuels often results in the production of some undesirable constituents such as unburned hydrocarbons and carbon monoxide (CO) in exhaust emissions.

Air pollution concerns have led to government regulations that regulate emissions in GTE exhaust. One method used to reduce pollutants of GTEs is to use a well mixed lean fuel-air mixture (fuel-air mixture having a lower fuel to air ratio than a stoichiometric ratio) for combustion in the combustor. However, in some cases, using a lean fuel-air mixture may make combustion in the combustor unstable. To provide a stable flame while meeting emission regulations, some fuel injectors direct separate streams of a lean fuel-air mixture and a richer fuel-air mixture (via a pilot assembly) to the combustor. In such a fuel injector, a majority of the fuel is directed to the combustor as lean premixed fuel, while the pilot assembly provides a source of rich fuel to the combustor for flame stabilization and startup. That is, the lean fuel-air mixture may provide lower emissions, while the richer fuel-air mixture may provide flame stabilization during periods of flame instability. In order to inject fuel into the main lean fuel-air mixture or the richer fuel-air mixture of the pilot assembly, the fuel must be pressurized sufficiently to be injected in the high pressure compressed air stream exiting the compressor and entering the combustor. Increased fuel pressurization requires increased energy for operating the GTE.

U.S. Patent Application Publication No. 2009/0150040 A1 to Rolfka et al. (the '040 publication) discloses a method for controlling a GTE in a power plant. In particular, the '040 publication discloses a method of controlling an inlet guide vane of a compressor in a GTE. According to the '040 publication, the method allows for seamless load changes between operating lines by lowering or raising the turbine inlet or exhaust temperatures. The '040 publication, however, is silent regarding controlling the ratio of fuel flowing through the pilot assembly. As such, the method of the '040 publication may still suffer from fuel inefficiencies at some GTE loads.

### SUMMARY

Embodiments of the present disclosure may be directed to a method of controlling a turbine engine. The method may include adjusting a position of a plurality of guide vanes of a compressor. The adjusting the position of the plurality of guide vanes may be a function of a compressor temperature signal. The method may further include adjusting a quantity of fuel delivered to a combustor via a pilot assembly. The adjusting the quantity of fuel delivered to the combustor may be a function of a temperature difference resulting from the adjusting a position of the plurality of guide vanes.

In further embodiments, the present disclosure may include a control system for a turbine engine. The control system may include a guide vane controller. The guide vane controller may be configured to adjust a position of a plurality of guide vanes of the turbine engine as a function of a load of the turbine engine and a temperature of gasses in a turbine of the turbine engine. The control system may further include a fuel controller. The fuel controller may be configured to adjust an amount of fuel injected into the turbine engine via a pilot assembly as a function of the temperature of gasses in the turbine.

Further embodiments of the present disclosure may include a method of controlling a turbine engine. The method may include delivering a load signal and a turbine temperature signal to a guide vane controller. The turbine temperature signal may be indicative of a temperature of gasses in a turbine of the turbine engine. The method may further include adjusting a position of a plurality of guide vanes of a compressor of the turbine engine as a function of the received load signal and turbine temperature signal. Further, the method may include delivering the turbine temperature signal to a pilot controller. Also, the method may include controlling a pilot assembly of the turbine engine to adjust an amount of fuel injected into the turbine engine via the pilot assembly as a function of the turbine temperature signal.

### BRIEF DESCRIPTION OF THE DRAWINGS

FIG. 1 is an illustration of an exemplary GTE and control system;

FIG. 2 is a schematic of an exemplary control system of a GTE;

FIG. 3 is an exemplary control diagram of an exemplary control system of a GTE; and

FIG. 4 is a flow diagram of an exemplary method of controlling a GTE.

### DETAILED DESCRIPTION

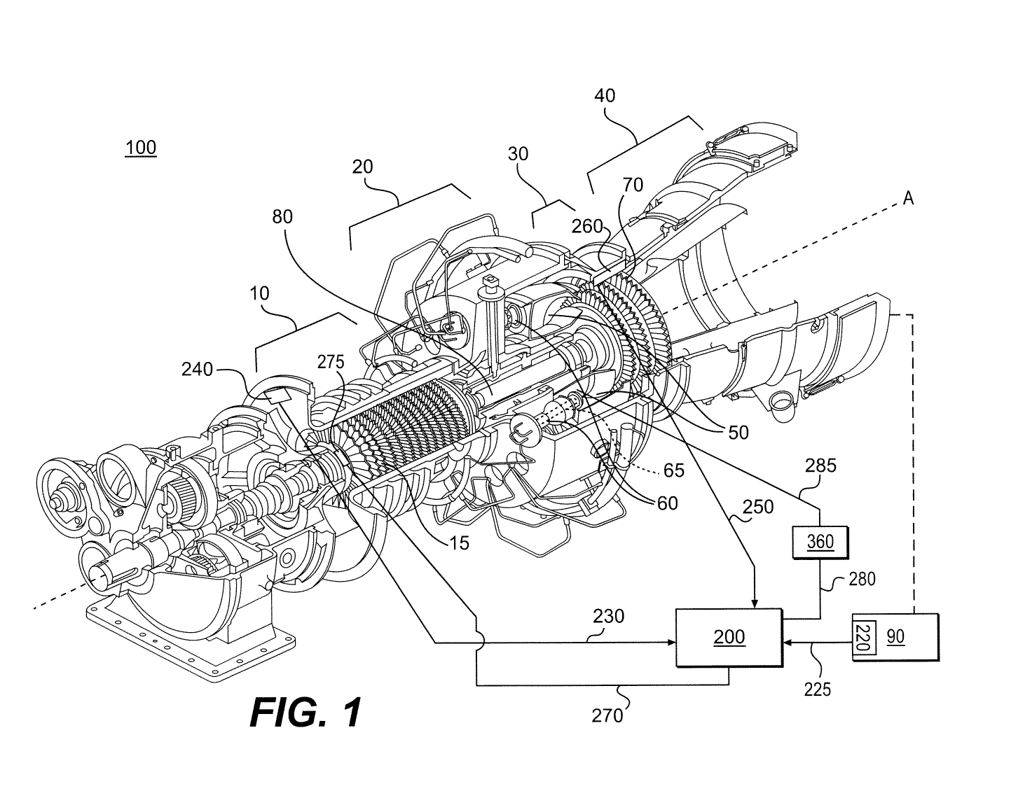

FIG. 1 illustrates an exemplary gas turbine engine (GTE) 100 having a compressor system 10, a combustor system 20, a turbine system 30, and an exhaust system 40 arranged lengthwise along an engine axis A. The compressor system 10 may include one or more stages of guide vanes 15 and rotor vanes 25 configured to compress air and deliver the compressed air to the combustor system 20. As described in further detail below, guide vanes 15 may be manipulatable so as to alter the angle the guide vanes 15 extends with respect to the engine axis A. That is, guide vanes 15 may be adjusted to alter the amount of air traveling through the compressor system 10 of the GTE 100. The compressed air may be mixed with a fuel and directed into a combustor 50 through one or more fuel injectors 60. Fuel injectors 60 may be configured to deliver a lean fuel-air mixture into the combustor system 20. The fuel injectors may further include a pilot assembly 65 therein. Pilot assembly 65 may be configured to deliver a rich fuel-air mixture into the combustor system 20. The fuel-air mixture may ignite and burn in the combustor 50 to produce combustion gases that may be directed to the turbine system 30. The turbine system 30 may extract energy from these combustion gases which may rotate turbine blades 70 and a shaft 80 of the GTE 100. The turbine system 30 may then direct the exhaust gases to the atmosphere through the exhaust system 40. Exhaust system 40 may then direct the exhaust gases to a device 90 to be driven by GTE 100. For example, device 90 may include a generator. Alternatively, device 90 may include any other device which may be driven by a GTE 100.

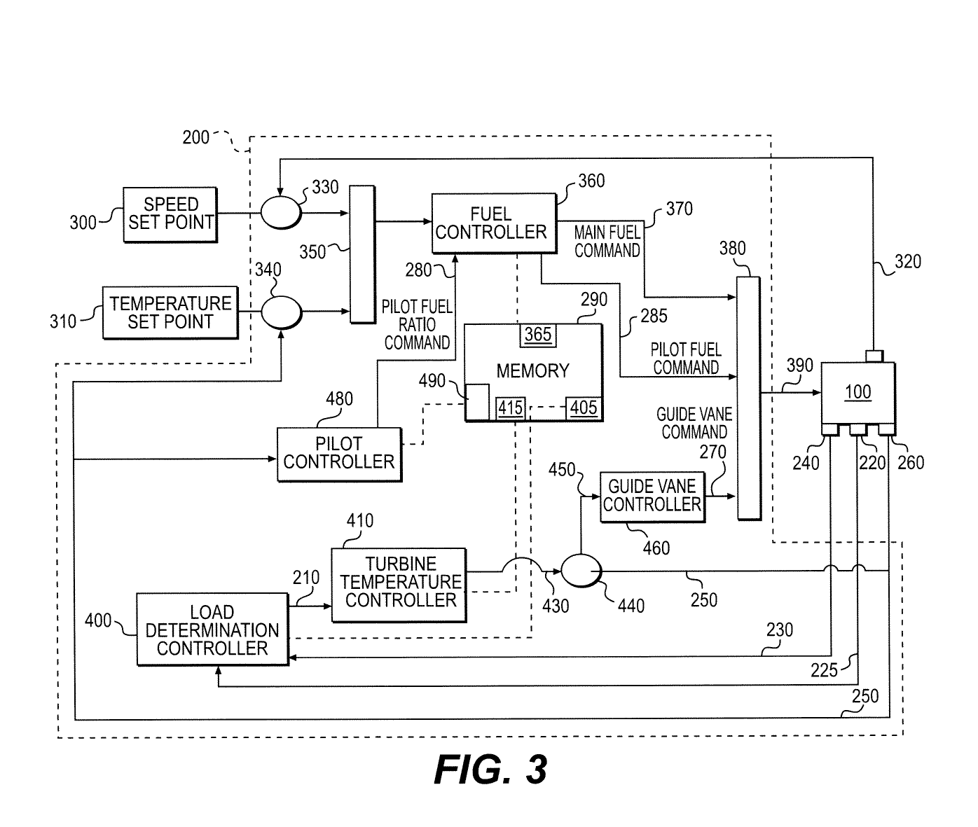

As shown in FIG. 1, a control system 200 may be operatively connected to the GTE 100. Control system 200 may be configured to receive signals from the GTE 100 and deliver control signals in response thereto. In particular, the control system 200 may be configured to receive an actual sensed power output signal 225 of the GTE 100. The actual sensed power output signal 225 may be transmitted from a device sensor 220 associated with the device 90 to be driven by the GTE 100 to the control system 200. For example, device sensor 220 may measure a power output of the device 90. The actual sensed power output signal 225 may be employed to determine a load signal 210 (FIG. 3) of the GTE 100. Load signal 210 may be indicative of the load of the GTE 100 at any given point. As will be discussed more fully below, load signal 210 is a function of the maximum available power and the actual sensed power output 225 of the GTE 100. The maximum available power will be calculated as described in further detail below.

Control system 200 may be further configured to receive an ambient temperature signal 230. The ambient temperature signal 230 may be transmitted to the control system 200 via an ambient temperature sensor 240. As shown in FIG. 1, the ambient temperature sensor 240 may be positioned in the compressor inlet duct so as to sense the temperature of air enter the GTE 100. Further, control system 200 may be configured to receive a turbine temperature signal 250. The turbine temperature signal 250 may be transmitted by a turbine temperature sensor 260. As shown in FIG. 1, the turbine temperature sensor 260 may be positioned in the turbine system 30. For example, the turbine temperature sensor 260 may be positioned at a second stage nozzle of the turbine system 30.

Upon receiving the actual sensed power output signal 225, the ambient temperature signal 230, and the turbine temperature signal 250, the control system 200 may be configured to deliver a number of control commands. For example, as shown in FIG. 1, the control system 200 may be configured to deliver a guide vane control command 270. Guide vane control command 270 may be transmitted to the compressor system 10 to control one or more stages of the guide vanes 15 therein. That is, guide vane control command 270, through an actuator 275, may direct one or more stages of the guide vanes 15 to alter the angle the guide vanes 15 extend with respect to the engine axis A. Upon receipt of the guide vane control command 270, actuator 275 may drive one or more stages of guide vanes 15 may be adjusted to move towards a “closed” position whereby the amount of air travelling through the compressor system 10 of the GTE 100 may be reduced. The “closed” position may be a position in which the guide vanes 15 are angled so as to reduce a flow area of the compressor 10 of the GTE 100. Alternatively, upon receipt of the guide vane control command 270, actuator 275 may drive one or more stages of guide vanes 15 to move towards an “open” position whereby the amount of air travelling through the compressor system 10 of the GTE 100 may be increased. The “open” position may be a position in which the guide vanes 15 are angled so as to increase a flow area of the compressor 10 of the GTE 100. Upon receipt of the guide vane control command 270, actuator 275 may adjust the guide vanes 15 through any appropriate means. By way of non-limiting example, such means may include one or more of the following: mechanical linkages, levers, gearing, etc. For example, a mechanical linkage (not shown) may be employed to adjust one or more stages of guide vanes 15 simultaneously.

Additionally, the control system 200 may be configured to deliver a pilot fuel ratio command 280. Pilot fuel ratio command 280 may be transmitted to the combustor system 20 to control the amount of fuel injected through a pilot assembly 65 therein. That is, pilot fuel ratio command 280 may be directed to a fuel controller 360 (FIG. 3) which may direct one or more valves of the pilot assembly 65 to inject more or less fuel into the compressed air stream entering the combustor system 20. For example, upon receiving the pilot fuel ratio command 280, the fuel controller 360 may be configured to transmit a pilot fuel command 285 (FIG. 3) to direct the pilot assembly 65 (including one or more valves) to adjust the amount of fuel injected via the pilot assembly 65. As such, the ratio of fuel entering the compressed air stream via the pilot assembly 65 in comparison to the main fuel injectors 60 is altered. Alteration of the pilot fuel ratio may achieve various benefits as explained in more detail below.

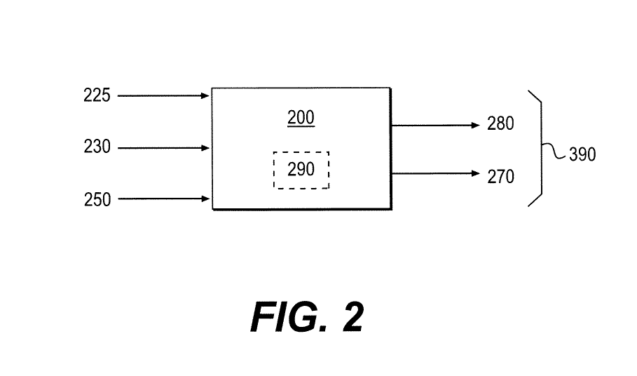

FIG. 2 illustrates an exemplary control system 200 of the GTE 100. As shown in FIG. 2, control system 200 is configured to receive the actual sensed power output signal 225, the ambient temperature signal 230, and the turbine temperature signal 250. The control system 200 may further include a memory 290. Memory 290 may include a number of look-up tables, algorithms, maps, or schedules that may be accessed to determine appropriate values for the guide vane control command 270 and the pilot fuel ratio command 280. That is, upon receipt of the actual sensed power output signal 225, the ambient temperature signal 230, and the turbine temperature signal 250, control system 200 may implement schedules stored in the memory 290 to determine appropriate values for the guide vane control command 270 and the pilot fuel ratio command 280. Upon determining appropriate values, the control system 200 is configured to deliver the guide vane control command 270 to the actuator 275 and the pilot fuel ratio command 280 to the fuel controller 360.

FIG. 3 illustrates an exemplary control diagram for control system 200. As shown in FIG. 3, a GTE speed set point 300 and a GTE temperature set point 310 may be input. These values may be operator set so as to determine the overall fuel command for the GTE 100. The values of the GTE speed set point 300 and GTE temperature set point 310 may be combined with an actual sensed GTE speed signal 320 and the turbine temperature signal 250 in first and second summers 330 and 340, respectively. The summed values may then be input into a bus 350. Bus 350 may be configured to receive the summed values and output a signal to a fuel controller 360. Fuel controller 360 may be configured to receive the signal from the bus 350 and apply any necessary error correction or processing to the signal. For example, fuel controller 360 may be configured to access the memory 290 and apply any appropriate modification to the received signal, such as a minimum error fuel correction 365 stored in the memory 290. Fuel controller 360 may further be configured to deliver a main fuel command signal 370 directing one or more valves of the main fuel supply through the fuel injector(s) 60 to a second bus 380. Main fuel command 370 may be indicative of the amount of fuel to be injected into the combustor 60 through main fuel injectors 60. Bus 380 may be configured to deliver a combined signal 390, including the main fuel command signal 370, to the GTE 100.

As further shown in FIG. 3, the ambient temperature signal 230 may be delivered from the ambient temperature sensor 240 in the compressor system 10 to a load determination controller 400. The maximum power a GTE is able to produce is a function of temperature. Accordingly, the load determination controller may be configured to process the received ambient temperature signal 230 to determine the maximum power output of the GTE 100 for example, by accessing a power schedule 405 in memory 290.

The load determination controller 400 may further be configured to receive the actual sensed power output signal 225 via the device sensor 220 associated a device 90 driven by the GTE 100. Upon determining the maximum power based on the ambient temperature signal 230, and upon receiving the actual sensed power output signal 225 from device sensor 220, the load determination controller 400 may be configured to determine the load signal 210. For example, the load determination controller 400 may process and/or perform a calculation with the actual sensed power output signal 225 and the previously determined maximum power to determine the load signal 210. Further, the load determination controller 400 may be configured to transmit the load signal 210 to a turbine temperature controller 410. For any given value of load signal 210, turbine temperature controller 410 may be configured to determine a turbine temperature set point. That is, the turbine temperature set point of the GET 100 is a function of the load on GTE. The turbine temperature controller may, for example, be configured to access a turbine temperature schedule 415 located in the memory 290.

Upon determination of the turbine temperature set point for a given GTE 100 load signal 210, the turbine temperature controller 400 may be configured to transmit a turbine temperature set point signal 430 to a third summer 440. Summer 440 may further be configured to receive turbine temperature signal 250, that is, the actual sensed value of the turbine temperature from turbine temperature sensor 260. After receiving the turbine temperature set point signal 430 and the turbine temperature signal 250, summer 440 may be configured to transmit a combined temperature signal 450 to a guide vane controller 460. As will be discussed more fully below, the temperature of the turbine system 30 is a function of the degree of “opening” or “closing” of the guide vanes 15 of the compressor system 10. Therefore, upon receiving the combined temperature signal 450, the guide vane controller 460 may be configured to deliver the guide vane command signal 270. Guide vane command signal 270 may be transmitted from the guide vane controller 460 to bus 380. Bus 380 may, in turn, be configured to deliver a combined signal 390, including the guide vane command signal 270, to the GTE 100. Upon receipt of the guide vane command signal 270, the actuator 275 may adjust the plurality of guide vanes 15 so as to move towards an “open” or “closed” position.

As further shown in FIG. 3, turbine temperature signal 250 may be transmitted by the turbine temperature sensor 260 in the turbine system 30 to a pilot controller 480. As will be discussed in more detail below, as the turbine temperature increases, the flame becomes more stable. A stable flame does not require as much of the rich fuel of the pilot assembly 65 to sustain combustion in combustor system 20. Accordingly, the ratio of fuel injected into the combustor system via the pilot assembly 65 may decrease. As such, upon receiving the turbine temperature signal 250, the pilot controller 480 may access a pilot schedule 490 stored in memory 290. Pilot schedule 490 may correlate turbine temperature signal 250 with a corresponding pilot ratio command 280. That is, as the turbine temperature signal 250 increases in value, the pilot ratio command 280 may direct the combustor system 20 to reduce the ratio of fuel injected via the pilot assembly 65 into the combustor system 20. The pilot controller 480 may be configured to transmit the pilot ratio command 280 to the fuel controller 360. Fuel controller 360, as a function of the pilot fuel ratio command 280, may adjust the main fuel command 370. That is, fuel controller 360 may alter the value of the main fuel command 370 so as to increase or decrease the amount of fuel injected into the combustor 50 via the main fuel injectors 60. Additionally, fuel controller 360 may determine a pilot fuel command 285. That is, fuel controller 360 may determine an amount of fuel to be injected into the combustor 50 via the pilot assembly 65. As shown in FIG. 3, each of the main fuel command 370 and pilot fuel command 285 may be transmitted from the fuel controller 360 to the bus 380. Bus 380 may be configured to deliver the combined signal 390, including main fuel command 370 and pilot fuel command 285, to the GTE 100.

### INDUSTRIAL APPLICABILITY

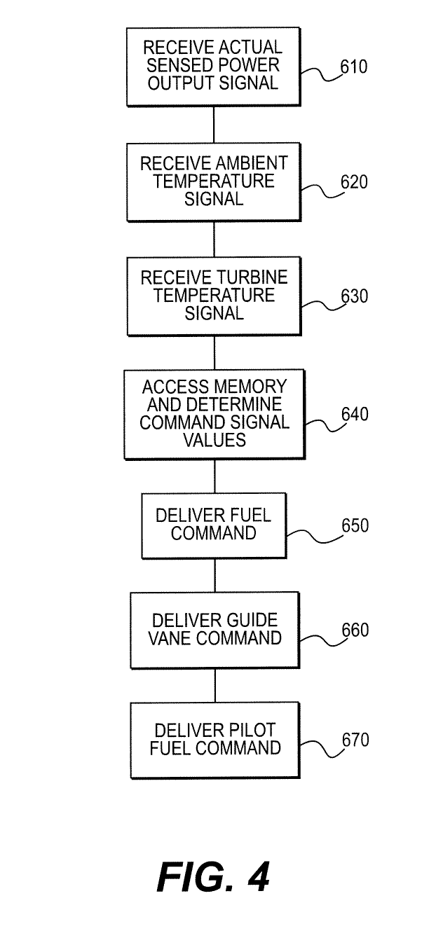

As shown in FIG. 4, a method of operating control system 200 is disclosed. The method may include, for example, receiving the actual sensed power output signal 225 via the device sensor 220 associated with the device 90 driven by the GTE 100 at step 610. At step 620, the control system 200 may further receive the ambient temperature signal 230 via the ambient temperature sensor 240. Next, the control system 200 may receive the turbine temperature signal 250 transmitted from the turbine temperature sensor 260 at step 630.

At step 640, the control system 200 may be configured to retrieve information from memory 290. For example, the control system may retrieve values to calculate and/or determine appropriate values for main fuel command 370, guide vane command 270, and pilot ratio command 280. Upon determination of these values, the control system 200 may further be configured to deliver the main fuel command 370 at step 650. Additionally, the control system 200 may be configured to deliver the guide vane command 270 at step 660. Finally, the control system 200 may be configured to deliver the pilot fuel command 285 at step 670. In this manner, the control system 200 may be configured to dynamically control the GTE 100 to improve efficiency and reduce undesirable emissions.

The presently disclosed GTE 100 control system 200, may achieve numerous benefits. GTE 100 runs inefficiently, for example, under 80% combustion efficiency at low loads, such as, for example, loads of 50% or less. This low efficiency results in an increase in unburned fuel, which results in an increase in emissions such as unburned hydrocarbons and CO. To improve GTE 100 efficiency and to reduce emissions, the control system 200 adjusts the angle of the guide vanes 15. For example, tilting the guide vanes 15 towards a “closed” position, reduces the amount of air entering compressor system 10. Accordingly, the compressor system 10 receives less air to compress and transmit to the combustor system 20, and thus, less air to be mixed with injected fuel in the combustor system 20.

Due to the restricted amount of air passing through the compressor system 10 to the combustor system 20, the air pressure in the combustor system is reduced. Since there is reduced air pressure in the combustor section in the vicinity of the fuel injectors 60 inlets, less pressure is required to inject the fuel through fuel injectors 60. Because there is lower fuel pressure required, less energy is required to pressure the fuel to be injected via the fuel injectors 60.

Further, by decreasing the amount of air entering the combustor, the air-fuel ratio is altered. The ratio becomes richer. Richer air-fuel mixtures burn at higher temperatures. By operating at a higher temperature, CO and hydrocarbons in the emissions are reduced. That is, the higher the temperature in the GTE 100, the more CO and hydrocarbons are burned in the combustor system 20. Consequently, as more CO and hydrocarbons are burned, less CO and hydrocarbons are emitted into the atmosphere via the exhaust system 40.

Additionally, as the GTE 100 operates at a higher temperature, the efficiency of the GTE 100 is improved. As such, less fuel is required for operation of the GTE 100. In addition to controlling the compressor guide vanes 15, the control system 200 may control one or more valves of the pilot assembly 65. Because the GTE 100 operates at a higher temperature, the flame in the combustor system 20 has an increased stability. Because the flame of the combustor system 20 is more stable, less fuel is required to be injected through pilot assembly 65.

Further, the control system 200 may improve liquid to gas fuel transfers. Indeed, liquid to gas fuel transfers are often plagued by fluctuations in output power. For example, the amount of fuel required to operate the GTE 100 on gas is significantly different than the amount of fuel required to operate the GTE 100 on liquid. Such discrepancies cause speed and stability issues while switching from liquid fuel to gas fuel. The control system 200 of the presently disclosed embodiments may be operated to control the liquid and gas fuels to the same turbine temperature by means of the inlet guide vanes 15. That is, the control system 200 may control the guide vanes 15 to “open” completely. In such a configuration, an increase in air is produced and the fuel-air mixtures becomes increasingly lean. At such a time, the control system 200 may control the pilot assembly 65 to inject more fuel to stabilize the flame in combustor 50 of the GTE 100. Such control allows smoother liquid to gas fuel transfers.

It will be apparent to those skilled in the art that various modifications and variations can be made to the disclosed control system and methods. Other embodiments will be apparent to those skilled in the art from consideration of the specification and practice of the disclosed embodiments. It is intended that the specification and examples be considered as exemplary only, with a true scope being indicated by the following claims and their equivalents.

What is claimed is:

1. A method of controlling a turbine engine, comprising:
adjusting a position of a plurality of guide vanes of a compressor as a function of a compressor temperature signal; and
adjusting a quantity of fuel delivered to a combustor via a pilot assembly as a function of a temperature difference resulting from the adjusting a position of the plurality of guide vanes.

2. The method of claim 1, wherein adjusting the position of the plurality of guide vanes further includes adjusting the position of the plurality of guide vanes as a function of a load signal of the turbine engine.

3. The method of claim 1, further including:
determining a main fuel command for the turbine engine as a function of a turbine temperature signal.

4. The method of claim 1, further including:
adjusting the position of the plurality of guide vanes during a fuel transfer between a liquid fuel and a gas fuel.

5. The method of claim 1, wherein the temperature difference resulting from the adjusting a position of the plurality of guide vanes is measured in a turbine of the turbine engine.

6. A control system for a turbine engine, comprising:
a guide vane controller configured to adjust a position of a plurality of guide vanes of the turbine engine as a function of a load of the turbine engine and a temperature of gasses in a turbine of the turbine engine; and
a fuel controller configured to adjust an amount of fuel injected into the turbine engine via a pilot assembly as a function of the temperature of the gasses in the turbine.

7. The control system of claim 6, wherein adjustment of the position of the plurality of guide vanes is also a function of a temperature of gasses in a compressor of the turbine engine.

8. The control system of claim 7, wherein the temperature of the gasses in the compressor is sensed at an inlet of the compressor.

9. The control system of claim 6, wherein the fuel controller is further configured to determine a main fuel command for the turbine engine as a function of the temperature of gasses in the turbine.

10. The control system of claim 6, further including a turbine temperature sensor positioned in the turbine of the turbine engine and configured to deliver a signal indicative of said temperature of said gasses in the turbine.

11. The control system of claim 6, further including a compressor temperature sensor positioned in a compressor of the turbine engine and configured to deliver a signal indicative of a temperature of gasses in the compressor.

12. The control system of claim 6, further including a power sensor associated with a device driven by the turbine engine and configured to deliver a power signal.

13. A method of controlling a turbine engine, comprising:
delivering a load signal and a turbine temperature signal to a controller, the turbine temperature signal indicative of a temperature of gasses in a turbine of the turbine engine;
adjusting a position of a plurality of guide vanes of a compressor of the turbine engine as a function of the received load signal and turbine temperature signal;
delivering a subsequent turbine temperature signal to the controller; and
controlling a pilot assembly of the turbine engine to adjust an amount of fuel injected into the turbine engine via the pilot assembly as a function of the subsequent turbine temperature signal.

14. The method of claim 13, further including:
delivering a compressor temperature signal to the controller; and
wherein the adjusting the plurality of the guide vanes of the compressor is a further function of the compressor temperature signal.

15. The method of claim 14, further including:
sensing a temperature of the gasses in the compressor corresponding to the compressor temperature signal at an inlet of the compressor.

16. The method of claim 13, further including:
determining a main fuel command for the turbine engine as a function of the turbine temperature signal.

17. The method of claim 13, further including:
sensing the temperature of gasses in the turbine corresponding to the turbine temperature signal via a turbine temperature sensor positioned in the turbine of the turbine engine.

18. The method of claim 13, further including:
accessing a stored memory of the controller to determine at least one of a main fuel command, a pilot fuel command, and guide vane command.

19. The method of claim 13, further including:
sensing a power signal via a power sensor associated with a device driven by the turbine engine;
wherein the adjusting of the position of the plurality of guide vanes of the compressor is a further function of the power signal.

20. The method of claim 13, wherein the adjusting of the position of the plurality of guide vanes takes place during a fuel transfer between a liquid fuel and a gas fuel.
